(19) United States
(12) Patent Application Publication
(10) Pub. No.: US 2025/0140971 A1
(43) Pub. Date: May 1, 2025

(54) COOLING DEVICE FOR AN ELECTRIC BATTERY

(71) Applicant: HUTCHINSON, PARIS (FR)

(72) Inventors: Jean-Yves MOUNIER, PAUCOURT (FR); Nicola MORETTI, GASSINO TORINESE (IT); Franco VIROGLIO, CHIVASSO (IT)

(21) Appl. No.: 18/929,323

(22) Filed: Oct. 28, 2024

(30) Foreign Application Priority Data
Oct. 31, 2023 (FR) 2311875

(51) Int. Cl. H01M 10/6556; H01M 10/613; H01M 10/625; H01M 50/204

(52) U.S. Cl. CPC H01M 10/6556; H01M 10/613; H01M 10/625; H01M 50/204

(57) ABSTRACT

Cooling device for a battery includes a casing formed from two sheets of flexible material, a circulation channel, an inlet orifice for fluid and an outlet orifice, and at least one fluidic connector arranged through the inlet or outlet orifice. The fluidic connector includes a base having a base plate defining a central through-opening, the base plate defining an upper face arranged against an inner face of the sheet, a tube integral with the base plate, extending through the inlet orifice or the outlet orifice and leading through the central opening, and a ring assembled on the base and circumferentially surrounding the tube, arranged to bear against an outer face of the sheet, the upper face of the base plate being fixed to the inner face of the sheet by at least one weld circumferentially surrounding the tube.

### CROSS REFERENCE TO RELATED APPLICATIONS

This application claims priority to French Patent Application No. 2311875 filed Oct. 31, 2023, hereby incorporated in its entirety

### TECHNICAL FIELD

The invention relates to the technical field of electric batteries, and more precisely to the cooling of said batteries. Said batteries are for example installed in a vehicle having electric or hybrid propulsion.

In this respect, the invention relates to a cooling device for an electric battery.

The invention also relates to an electric battery comprising such a cooling device.

### BACKGROUND

In an electric battery with cells, i.e. a battery comprising several independent battery elements grouped in an enclosure, the hottest elements are located in the center of the enclosure. As the elements are generally arranged so that their side faces are in contact with each other in order to reduce their overall size, the heat generated by these most hemmed-in elements is only discharged at their lower faces.

Indirect fluid cooling is the method most commonly used by manufacturers, because it is effective, fairly simple to set up, and inexpensive. This method consists of circulating a coolant (usually a water-glycol mixture) in a cooling device located under the battery elements. The fluid acts as a heat transfer fluid and draws heat energy from the battery in order to carry it away to outside the enclosure as it circulates.

As a result, the removal of heat is highly dependent on the thermal resistance in the exchange between the lower face of the battery elements and the cooling device.

In order to improve this thermal resistance, it is known to use thermal interface materials, such as thermally conductive resins, between the cold plate of the cooling device and the lower surfaces of the battery elements, to fill in local gaps between these surfaces due to irregularities in these solid structures and their roughness. However, such a solution significantly increases the cost and mass of the battery. In addition, the thermal contact enabled by the use of such an interface material remains significantly less effective than a direct mechanical contact between conductive metal materials.

Another possibility for improving thermal contact is to use a flexible casing for the circulation of coolant instead of a rigid structure, this flexible casing deforming freely under the pressure from the circulating coolant and thus coming to fit snugly against the contours of the lower surface of the battery elements, thereby providing good thermal contact.

The flexible casing is designed using two film sheets made of multiple materials and multiple layers, assembled by local welding so as to form one or more channels for the circulation of fluid. The two sheets may be separate or may be formed by a single sheet folded onto itself.

Such a casing thus makes it possible to have a cooling device benefiting from good thermal contact with the battery elements to be cooled, while being light and simple to manufacture compared to the rigid coolers of the prior art.

However, the connection of a casing made of flexible material to a coolant distribution circuit comprising rigid pipe elements can pose fluidtightness issues, particularly over the long term and during significant thermal variations in the environment close to the connectors.

### SUMMARY

The invention aims to overcome these disadvantages by providing a battery cooling device using a flexible casing for the circulation of coolant and having improved fluidtightness that is better guaranteed over time.

For this purpose, the invention relates to a cooling device for an electric battery, the cooling device comprising:
a casing formed from two sheets of flexible material which extend facing one another, the sheets having weld regions where the sheets are secured to one another and separation regions where the sheets are able to extend at a distance from one another,
at least one fluid circulation channel extending between the sheets through at least one of the separation regions,
at least one inlet orifice for fluid, defined in one of the sheets, and at least one outlet orifice for fluid, defined in one of the sheets, and
at least one fluidic connector, each fluidic connector being arranged traversing the at least one inlet orifice or the at least one outlet orifice, fixedly mounted to the corresponding sheet,
characterized in that each fluidic connector comprises:
a base comprising:
a base plate defining a central through-opening, the base plate defining an upper face arranged against an inner face of the corresponding sheet, and
a tube integral with the base plate, extending through the inlet orifice or the outlet orifice and leading through the central opening of the base plate,
a ring assembled on the base and circumferentially surrounding the tube, the ring being arranged to bear against an outer face of the sheet,
the upper face of the base plate being fixed to the inner face of the sheet by at least one weld circumferentially surrounding the tube.

Such a cooling device allows a fluid connection of the flexible casing to a coolant distribution circuit which allows an improved fluidtightness that is better guaranteed over time.

Each fluidic connector may comprise at least one rib extending on the base plate, in contact with the inner face of the sheet and circumferentially surrounding the tube, each rib defining a ridge line by which the base is fixed to the sheet by welding.

Such a feature makes it possible to have precise weld lines that are simple to produce by thermal welding on the ridge lines of the ribs.

The base plate may have a general disk shape, and each rib may extend along a circular contour centered on the central opening of the base plate.

Such a feature makes it easier to form the welds between the base plate and the sheet and for the welds to have better mechanical strength.

The connector may further comprise at least one O-ring arranged between the base plate of the base and the inner face of the sheet, the ring exerting force on the O-ring through the sheet.

Such a feature makes it possible to further reinforce the fluidtightness of the connector by adding a second sealing means that is complementary to the welds.

The base may comprise at least two ribs spaced radially apart from each other relative to the tube and fixed to the sheet by their respective ridge lines, the at least two of the ribs defining between them an annular groove receiving the O-ring.

Such a feature further improves the fluidtightness and durability of the connector by adding a second weld line, and simplifies the installation and retention in position of the O-ring.

An inner surface of the ring and an outer surface of the tube may have corresponding threads, arranged to allow fixing the ring to the base.

Such a feature allows a simplified and reversible assembly of the ring on the tube and a proper maintaining of pressure on the O-ring.

The ring and the tube may have corresponding snap-fastening means, arranged to allow fixing the ring to the base.

Such a feature allows a simplified and reversible assembly of the ring on the tube and a proper maintaining of pressure on the O-ring.

Said snap-fastening means may comprise a plurality of teeth distributed circumferentially on the outer surface of the tube and projecting radially from said outer surface, and, preferably, a same number of corresponding indentations defined by the ring.

Such a feature makes it possible to have radially distributed mechanical stresses, thus improving the durability and fluidtightness of the connector.

An inner surface of the tube may have reliefs arranged to generate turbulence in a flow of fluid through the tube.

Such a feature allows improving the mixing of the coolant in the circulation channel and thus increasing the cooling efficiency. In particular, these reliefs make it possible to prevent the appearance of a stationary layer of fluid along the walls which would reduce the efficiency of the heat transfer, by remixing this layer of fluid into the central flow.

The reliefs may have the shape of ramps extending on the inner surface of the tube in a direction transverse to the local direction of elongation of the tube, projecting towards the inside of the tube.

Such a feature makes it possible to have reliefs that are simple to form and have good durability, and encourages the mixing of peripheral fluid into the center of the flow.

The invention also relates to an electric battery comprising:
a plurality of battery elements arranged in an enclosure,
a coolant circulation device, and
a cooling device as above, each fluidic connector of the cooling device being fluidly connected to the coolant circulation device,
the casing being arranged to come into contact with elements to be cooled among the battery elements when a coolant is circulating in the at least one circulation channel.

### BRIEF DESCRIPTION OF THE FIGURES

FIG. 1 is an exploded perspective view of the main elements of an electric battery according to the invention,

FIG. 2 is an exploded perspective view of a cooling device for the battery of FIG. 1,

FIG. 3 is a cross-section view of the cooling device of FIG. 2,

FIG. 4 is a detailed perspective view showing means of assembling the cooling device of FIGS. 1 and 2,

FIG. 5 is a perspective view of a base of a fluidic connector of the cooling device of FIGS. 2 to 4,

FIG. 6 is a perspective view of the base of FIG. 5 when carrying an O-ring,

FIG. 7 is a perspective view of the fluidic connector of FIGS. 5 and 6, assembled, and

FIG. 8 is a cross-section view of the connector of FIGS. 5 to 7.

### DETAILED DESCRIPTION

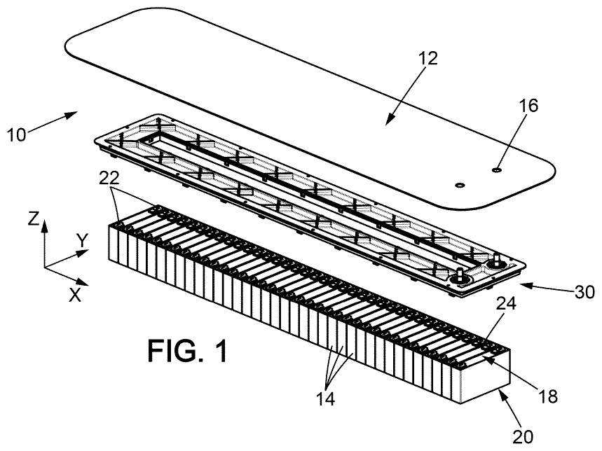

FIG. 1 shows an electric battery 10 intended for storing energy, intended in particular for applications on board a vehicle, for example a vehicle with electric or hybrid propulsion.

Said vehicle is for example a motor vehicle, a road or rail transport vehicle, a maritime vehicle, or some other vehicle.

Alternatively, battery 10 is intended for a fixed or mobile installation requiring a supply of electrical energy with no connection to the power grid or in addition to such a connection.

The battery comprises a closed, substantially sealed enclosure 12 (only the cover is shown in the figures, for clarity), and a plurality of battery elements 14, or cells, arranged in enclosure 12 and capable of storing electrical energy.

Enclosure 12 comprises a removable upper cover, partially represented in FIG. 1, which defines ports 16 intended for the supply of coolant.

Each battery element 14 has a general shape that is substantially parallelepiped and thus defines an upper face 18, a lower face 20, and four side faces.

The expressions “upper” and “lower” are understood here to be relative to a standard positioning of the battery in operating condition.

Battery elements 14 are arranged in alignment in at least one row extending in an alignment direction X. In addition, an elevation direction Z and a transverse direction Y are defined, both perpendicular to each other and perpendicular to alignment direction X, elevation direction Z being oriented substantially vertically in a standard operating orientation of battery 10.

Battery elements 14 may be arranged in contact with each other by their respective side faces, along alignment direction X, or with small gaps between two neighboring battery elements along alignment direction X.

Each battery element 14 comprises connectors 22 arranged on its upper face 18, one on either side of said upper face along transverse direction Y. Connectors 22 of the battery elements thus form two rows extending along alignment direction X.

Connectors 22 of battery elements 14 are connected to parallel bus-bars 24 which extend substantially along alignment direction X, allowing energy to be supplied to battery elements 14 for the storage or removal of energy from the battery elements in order to power an electrical device.

Battery 10, and more particularly battery elements 14, generate heat during operation and require cooling for optimal operation and in order to provide a satisfactory operating time and satisfactory safety.

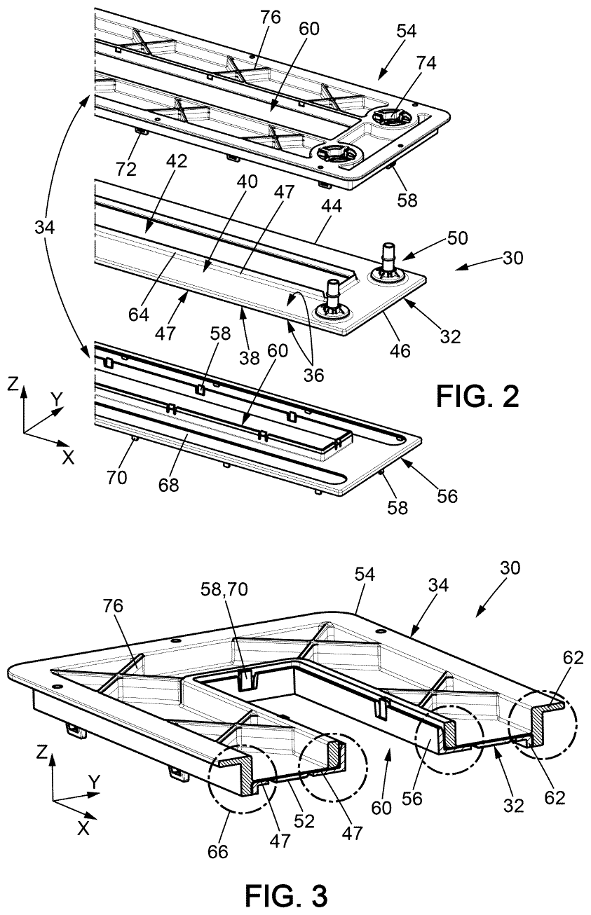

For this purpose, battery 10 comprises at least one cooling device 30 for the elements to be cooled in the battery, shown in more detail in FIGS. 2 to 4.

The elements to be cooled may be battery elements 14, and more specifically lower faces 20 or side faces of the battery elements, or connectors 22 of the battery elements as well as bus-bars 24, which are arranged above the upper faces of the battery elements.

In the example shown in the figures, cooling device 30 is thus arranged to cool connectors 22 of the battery elements, and bus bars 24, and is thus positioned in enclosure 12, suspended from the cover, above battery elements 14.

Cooling device 30 comprises a flexible casing 32 intended to accommodate the coolant, as well as a support structure 34 adapted to improve the rigidity and strength of cooling device 30.

Casing 32 is formed of two sheets 36 of flexible material extending facing one another and partially welded to one another.

Thus, casing 32 has weld regions 38 where sheets 36 are secured to each other, and separation regions 40 where sheets 36 are not welded to each other and are thus able to extend at a distance from each other, defining an internal space between them.

Weld regions 38 follow in particular an outer edge of casing 32, so as to seal off an internal space of casing 32.

Sheets 36 are formed from a multilayer film that is cut to obtain the desired geometry.

The film is for example a stack of layers as follows: a first layer of polyethylene terephthalate (PET), a layer of aluminum (Al), a second layer of polyethylene terephthalate, and a layer of polyethylene (PE). This type of film is commonly used in the food industry, for an advantageous insulation of products.

In the case of flexible casing 32, the aluminum layer provides very good thermal conductivity and reduces the risk of fluid permeating through the sheets, the layers of polyethylene terephthalate provide good resistance to temperature and to the ambient environment, and the polyethylene layer serves as an adhesive layer, for fixing the two sheets by fusing the two layers of polyethylene that are in contact with each other.

In the example shown, flexible casing 32 has a substantially rectangular shape and defines a rectangular central opening 42. The rectangular shape of casing 32 comprises, for example, two long sides 44 which extend in alignment direction X, and two short sides 46 which extend in transverse direction Y.

Casing 32 defines lateral edges 47, in particular external lateral edges 47 extending along the long sides and the short sides, as well as internal lateral edges 47 which run along central opening 42.

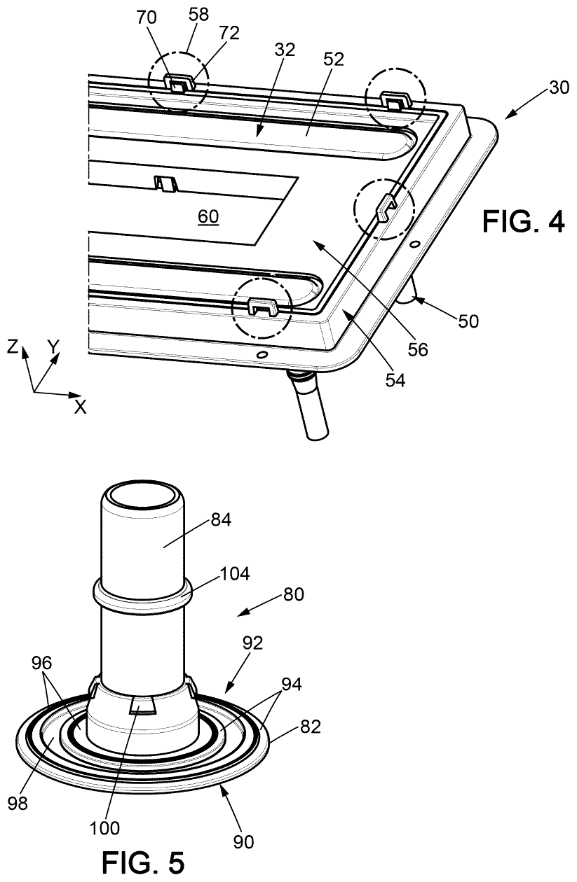

Cooling device 30 further comprises at least one inlet fluidic connector 50 and at least one outlet fluidic connector 50 which are arranged in the casing, and at least one fluid circulation channel 52, shown in FIGS. 3 and 4, extending between sheets 36 of the casing from the at least one inlet connector 50 to the at least one outlet connector 50.

Together, separation regions 40 of sheets 36 define said at least one fluid circulation channel 52 in the internal space.

In the example shown, inlet and outlet fluidic connectors 50 are positioned on the same side of the rectangular shape of casing 32.

For example, the two fluidic connectors 50 are positioned on the same short side 46 of the rectangular shape of casing 32, meaning at the same end of casing 32 along alignment direction X, one on either side of said rectangular shape along transverse direction Y.

In the example shown, casing 32 comprises a single fluid circulation channel 52 having a U shape, meaning that channel 52 extends from inlet connector 50 along one of long sides 44, then along short side 46 opposite connectors 50, and along the other of long sides 44 to the outlet connector.

More generally, channel 52 extends along a path forming at least one round trip on casing 32, in order to extend along the two rows of connectors 22 of battery elements 14 and allow a fluid connection of the inlet and the outlet at the same lateral edge 47 of casing 32.

Channel 52 may also extend along a path which winds along the extent of casing 32, i.e. forming at least one meander, which increases the cooled surface area.

Channel 52 may thus have a V shape, a W shape, etc.

Alternatively, casing 32 may comprise several channels 52 diverging from at least one inlet point and grouping back together at at least one outlet point.

In another alternative, casing 32 may comprise a plurality of channels 52 that are fluidly separate from each other.

In particular, casing 32 may comprise two substantially rectilinear and mutually parallel channels 52, extending along the two rows of connectors 22 and the bars 24, in alignment direction X.

Cooling device 30 may advantageously further comprise a rigid support structure 34 for flexible casing 32.

The expressions “rigid” and “flexible” are understood here to be relative to each other. In addition, the flexible nature of casing 32 implies that without external action, the casing deforms under the effect of its own weight, while the rigid nature of support structure 34 implies that it does not undergo any significant deformation under the effect of its own weight.

Support structure 34 comprises a first part 54 and a second part 56, as well as means 58 of assembling second part 56 and first part 54.

In the example considered, support structure 34 and casing 32 are intended to be arranged above battery elements 14.

First part 54 is therefore an upper part, arranged above second part 56 in elevation direction Z, second part 56 therefore being a lower part.

Second part 56 and first part 54 are shaped to clasp between them at least one of lateral edges 47 of casing 32, when they are assembled.

Thus, flexible casing 32 is held by its lateral edges 47, which are clasped by and supported between first and second parts 54, 56 of support structure 34.

First part 54 and second part 56 each have, for example, the shape of a flat rectangular frame extending perpendicularly to elevation direction Z, defining a central opening 60, first part 54 and second part 56 thus having respective external edges and internal edges.

Advantageously, first part 54 and second part 56 comprise flanges 62 which extend along external lateral edges and/or internal lateral edges, projecting in elevation direction Z.

Advantageously, flexible casing 32 may comprise flaps 64 extending along internal lateral edges 47 of casing 32 and running along central opening 42, these flaps 64 being held between flanges 62 of the first and second parts of support structure 34. This further improves the retention of the flexible casing between the two parts.

Advantageously, flanges 62 extending along the external lateral edges of first part 54 and second part 56 cooperate to form an external lateral flange 66 of support structure 34, arranged to be positioned along an outside edge of the set of battery elements 14, so as to simplify the installation of the cooling device and prevent its movement.

Second part 56 defines at least one hollowed-out portion 68 intended to provide an opening at at least one of separation regions 40 of casing 32, to allow casing 32 to protrude from support structure 34 through hollowed-out portion 68.

Each hollowed-out portion 68 has a shape identical to that of one of fluid circulation channels 52. Thus, in the example shown, there is one hollowed-out portion 68 which has a U-shape identical to that of fluid circulation channel 52 of casing 32.

This allows casing 32 to project through hollowed-out portion 68 along the entire extent of channel 52, in order to reach the elements to be cooled.

Each hollowed-out portion 68 has for example a substantially constant width along its length, measured transversely to the local direction of elongation of hollowed-out portion 68 and of coolant channel 52.

First part 54 is advantageously closed off opposite each hollowed-out portion 68 of second part 56. This allows maintaining counter-pressure on flexible casing 32, to prevent it from extending in an undesired direction.

Means 58 of assembling second part 56 to first part 54 are for example snap-fastening means of assembling comprising at least one tooth 70 projecting from an edge of one among the second part and first part and at least one corresponding indentation 72 defined by the other among the second part and the first part.

For example, means 58 of assembling comprise indentations 72 distributed along the inner rim and outer rim of first part 54, and corresponding teeth 70 distributed along the inner rim and outer rim of second part 56.

Advantageously, support structure 34 further comprises means of attachment, adapted to fix support structure 34 to the cover of electric battery enclosure 12.

The means of attachment are for example positioned on first part 54, along the outer rim.

The means of attachment for support structure 34 may additionally or alternatively be adapted to fix support structure 34 to a side or bottom wall of enclosure 12.

The means of attachment for support structure 34 may additionally or alternatively be adapted to fix support structure 34 to battery elements 14, in particular to bottom 20, side, or top 18 faces of battery elements 14.

The means of attachment for support structure 34 are for example means of attachment by snap-fastening, by screwing, or hinged means.

First part 54 defines at least one orifice 74 arranged to allow the passage of each fluidic connector 50 connected to casing 32. In the example shown, which has two connectors 50, first part 54 defines two orifices 74.

Orifices 74 are for example substantially circular, and are coincident with corresponding ports 16 defined in enclosure 12, in particular in the cover of enclosure 12.

Alternatively, at least one of orifices 74 is defined by second part 56, according to the configuration of connectors 50.

Advantageously, first part 54 comprises at least one stiffening rib 76, capable of improving the bending stiffness of support structure 34.

Ribs 76 extend for example along elevation direction Z, advantageously from the outer rim to the inner rim of first part 54.

In the example shown, first part 54 comprises a plurality of such ribs 76, forming crosspieces.

Support structure 34 is formed from plastic material, in particular by separately molding first part 54 and second part 56.

Alternatively, support structure 34 may be formed by stamping or by additive manufacturing. Alternatively, cooling device 30 may comprise a simplified support structure, such as a simple rigid frame clasping the external lateral edges of casing 32, or even no support structure 34, in particular when casing 32 is arranged in a receptacle or directly at the bottom of enclosure 12, in contact with the lower faces of battery elements 14.

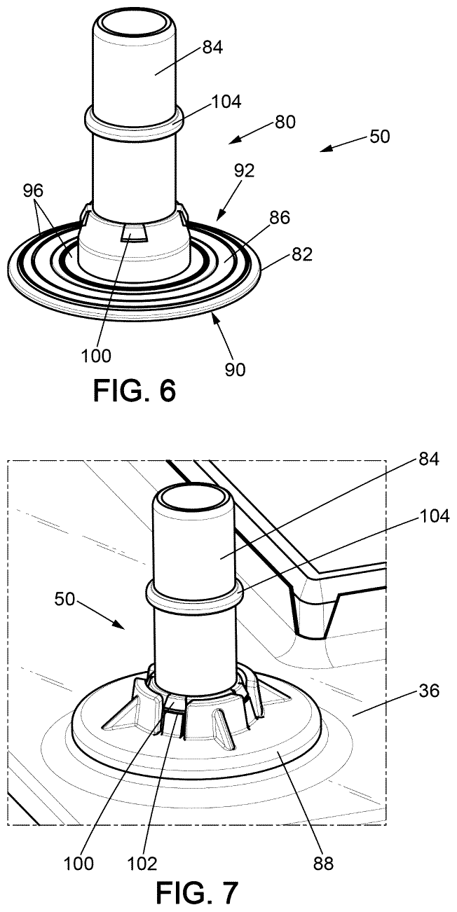

According to the invention, inlet and outlet fluidic connectors 50 are for example of the type shown in FIGS. 5 to 8.

Fluidic connectors 50 are arranged in respective inlet or outlet orifices made in sheets 36 forming casing 32.

Each fluidic connector 50 comprises a base 80 formed by a base plate 82 arranged internally relative to sheet 36 and a tube 84 secured to base plate 82 and extending through the orifice of sheet 36.

Base plate 82 is substantially perpendicular to the elevation direction in the example shown, while tube 84 extends substantially along elevation direction Z.

Each fluidic connector 50 further comprises a ring 88 assembled to base 80, resting against an outer surface of sheet 36.

Advantageously, each fluidic connector 50 further comprises at least one O-ring 86, arranged between base plate 82 of base 80 and the inner face of sheet 36.

In this case, ring 88 compresses the sheet and said O-ring(s) 86 against base 80.

Base plate 82 defines a central through-opening 90 through which the mouth of tube 84 leads into the internal space of flexible casing 32.

For example, base plate 82 has a general disk shape, concentric with central opening 90.

Base plate 82 further defines an upper face 92 by which connector 50 is fixed to the inner face of sheet 36, by a weld circumferentially surrounding tube 84 and extending around the orifice.

For example, connector 50 comprises for this purpose at least one rib 94 defined on base plate 82, circumferentially surrounding tube 84, and in particular at least two ribs 94 radially spaced apart from each other relative to tube 84.

Ribs 94 protrude from base plate 82 to a ridge line 96, by which they are fixed to the inner face of sheet 36.

The fixing of ribs 94 to sheet 36 is for example carried out by thermal welding of ridge line 96 to the internal polyethylene layer of sheet 36.

Ribs 94 are for example substantially circular and concentric.

Advantageously, ribs 94 define between them at least one groove 98 for receiving O-ring 86.

In the example shown, base 80 defines two such ribs 94, which allow having two weld lines for welding to sheet 36 and having a single O-ring 86 arranged in groove 98 formed between the two ribs 94.

Ring 88, shown in FIG. 7, is assembled to the base, for example by screwing or snap-fastening, and circumferentially surrounds tube 84.

In the example shown, tube 84 defines on its outer surface a plurality of teeth 100 regularly distributed around its circumference and which project radially from tube 84, while ring 88 defines a same number of corresponding indentations 102, shaped to receive teeth 100 by snap-fastening when ring 88 is fixed to base 80.

Alternatively, an outer surface of tube 84 may define a thread and an inner surface of ring 88 may define a complementary thread, said threads making it possible to fix ring 88 to base 80 by screwing.

Thus, ring 88 is arranged to rest against an outer face of sheet 36 and exerts force on O-ring 86 through the sheet, which allows having a reinforced seal in addition to the weld lines at ribs 94.

Tube 84 may also define a peripheral rib 104 for fixing a coolant conveyance pipe, which extends at a distance from ring 88, at the side away from base plate 82.

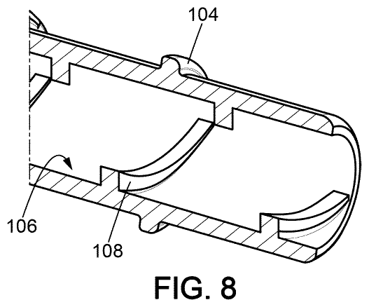

Advantageously, as shown in FIG. 8, an inner surface 106 of tube 84 has reliefs 108 arranged to generate turbulence in a flow of fluid through tube 84.

Said reliefs 108 have, for example, the shape of ramps extending over inner surface 106 of tube 84 in a direction transverse to the local direction of elongation of tube 84, protruding towards the interior of tube 84.

Such reliefs 108 allow improved mixing of the fluid flowing through tube 84 and allow avoiding the formation of a stagnant layer of fluid along inner surface 106, which would reduce the heat transfer efficiency.

1. A cooling device (30) for an electric battery, the cooling device (30) comprising:
a casing (32) formed from two sheets (36) of flexible material which extend facing one another, the casing (32) having weld regions (38) where the sheets (36) are secured to one another and separation regions (40) where the sheets (36) are able to extend at a distance from one another,
at least one fluid circulation channel (52) extending between the sheets (36) through at least one of the separation regions (40),90
at least one inlet orifice for fluid, defined in one of the sheets (36), and at least one outlet orifice for fluid, defined in one of the sheets (36), and
at least one fluidic connector (50), each fluidic connector (50) being arranged traversing the at least one inlet orifice or the at least one outlet orifice, fixedly mounted to the corresponding sheet (36),
characterized in that each fluidic connector (50) comprises:
a base (80) comprising:
a base plate (82) defining a central through-opening (90), the base plate (82) defining an upper face (92) arranged against an inner face of the corresponding sheet (36), and
a tube (84) integral with the base plate (82), extending through the inlet orifice or the outlet orifice and leading through the central through-opening (90) of the base plate (82),
a ring (88) assembled on the base (80) and circumferentially surrounding the tube (84), the ring (88) being arranged to bear against an outer face of the sheet (36), the upper face of the base plate (82) being fixed to the inner face of the sheet (36) by at least one weld circumferentially surrounding the tube (84).

2. The cooling device (30) according to claim 1, wherein each fluidic connector (50) comprises at least one rib (94) extending on the base plate (82), in contact with the inner face of the sheet (36) and circumferentially surrounding the tube (84), each rib (94) defining a ridge line (96) by which the base (82) is fixed to the sheet (36) by welding.

3. The cooling according to claim 2, wherein the connector further comprises at least one O-ring (86) arranged between the base plate (82) of the base (80) and the inner face of the sheet (36), the ring (88) exerting force on the O-ring (86) through the sheet (36).

4. The cooling device (30) according to claim 3, wherein the base (80) comprises at least two ribs (94) spaced radially apart from each other relative to the tube (82) and fixed to the sheet (36) by their respective ridge lines (96), the at least two of the ribs (94) defining between them an annular groove (98) receiving the O-ring (86).

5. The cooling device according to claim 1, wherein an inner surface of the ring (88) and an outer surface of the tube (84) have corresponding threads, arranged to allow fixing the ring (88) to the base (80).

6. The cooling device according to claim 1, wherein the ring (88) and the tube (84) have corresponding snap-fastening means, arranged to allow fixing the ring (88) to the base (80).

7. The cooling device (30) according to claim 6, wherein said snap-fastening means comprise a plurality of teeth (100) distributed circumferentially on the outer surface of the tube (84) and projecting radially from said outer surface, and, preferably, a same number of corresponding indentations (102) defined by the ring (88).

8. The cooling device according to claim 1, wherein an inner surface (106) of the tube (84) has reliefs (108) arranged to generate turbulence in a flow of fluid through the tube (84).

9. The cooling device (30) according to claim 8, wherein the reliefs (108) have the shape of ramps extending on the inner surface (106) of the tube in a direction transverse to the local direction of elongation of the tube (84), projecting towards the inside of the tube (84).

10. Electric battery (10) comprising:
a plurality of battery elements (14) arranged in an enclosure (12),
a coolant circulation device, and
the cooling device (30) according to claim 1, each fluidic connector (50) of the cooling device being fluidly connected to the coolant circulation device,
the casing (32) being arranged to come into contact with elements to be cooled among the battery elements when a coolant is circulating in the at least one circulation channel (52).
